(19) United States
(12) Patent Application Publication
(10) Pub. No.: US 2026/0021002 A1
(43) Pub. Date: Jan. 22, 2026

(54) SHOULDER STRETCHING APPARATUS

(71) Applicant: Blue Robin Inc., Seoul (KR)

(72) Inventors: Jae Heung PARK, Seoul (KR); Hyun Bum CHO, Seoul (KR); Kee Won KIM, Gyeonggi-do (KR); Sung Moon HUR, Seoul (KR); Sun Gun CHUNG, Seoul (KR)

(73) Assignee: Blue Robin Inc., Seoul (KR)

(21) Appl. No.: 18/996,472

(22) PCT Filed: May 23, 2023
(86) PCT No.: PCT/KR2023/006970

§ 371 Date: Jan. 17, 2025

(30) Foreign Application Priority Data
Jul. 18, 2022 (KR) 10-2022-0088158
Apr. 20, 2023 (KR) 10-2023-0051873

(51) Int. Cl. A61H 1/02

(52) U.S. Cl. CPC A61H 1/0281; A61H 2201/0192; A61H 2201/1616; A61H 2201/1664; A61H 2201/1671; A61H 2201/5007

(57) ABSTRACT

A shoulder stretching apparatus including a support shaft; a height adjustment unit; a link arm having one end connected to the height adjustment unit and extending to connect with a scapula control unit or a connecting portion; a scapula control unit having one end connected to the support shaft or the link arm, configured to hold the shoulder's axis and suppress the upward range of motion of the shoulder; a shoulder range-of-motion sensing unit having one end connected to the link arm, configured to measure the limit range of motion of the shoulder; an arm control unit connected to the other end of the shoulder range-of-motion sensing unit, configured to support the arm and control its movement; and a control unit configured to transmit commands to the scapula control unit and the arm control unit based on shoulder range-of-motion data received from the shoulder range-of-motion sensing unit.

### TECHNICAL FIELD

The present invention relates to a apparatus design for the purpose of rehabilitation treatment of patients with adhesive capsulitis. More specifically, it relates to a shoulder stretching assistance apparatus considering the scapulohumeral rhythm.

### BACKGROUND ART

According to statistics from the Ministry of Health and Welfare, the number of patients with adhesive capsulitis has been increasing annually. While the largest proportion of patients falls in their 50s, the growth rate among younger demographics, such as those in their 30s and 40s, is notably significant due to changes in lifestyle.

Adhesive capsulitis is a condition where inflammation occurs in the connective tissues of the shoulder joint, causing the surrounding tissues to tighten and stiffen, thereby restricting the range of motion of the joint. Typically, it starts with symptoms such as pain or stiffness in the shoulder and gradually progresses to a narrowing of the range of motion of the joint, and it is also known that metabolic disorders such as diabetes and thyroid diseases, or trauma, may be the causes.

For the treatment of adhesive capsulitis, there are non-conservative treatments such as surgery and conservative treatments such as medication and rehabilitation exercises, and although the choice of treatment depends on the condition of the patient, rehabilitation exercises are mostly recommended for treatment or prevention of recurrence.

However, in the case of rehabilitation exercises, it is not easy for patients with disrupted scapulohumeral rhythm to perform them correctly, and performing exercises incorrectly on their own can lead to other abnormal symptoms.

Scapulohumeral rhythm refers to the coordination of movements between the scapula and the thorax during shoulder movements, and the scapula plays an important role in assisting essential movements of the shoulder, while the thorax maintains stability and regulates motion of the shoulder in conjunction with the scapula.

Scapulohumeral rhythm may be understood as the concept that movements between the scapula and the thorax must occur in a specific ratio and pattern according to the principle that the scapula and thorax should move together during shoulder movements, and this is achieved through the regulation and coordination of the muscles involved in shoulder movements, and maintaining proper scapulohumeral rhythm greatly affects the efficiency and stability of shoulder movements.

Scapulohumeral rhythm can become problematic when shoulder movements become unnatural or imbalanced. In such cases, rehabilitation exercises focusing on improving scapulohumeral rhythm and restoring shoulder function through physical therapy may be necessary.

While such rehabilitation exercises are most effective when conducted under the supervision of a therapist, many hospitals face challenges related to costs, leading to a lack of professional therapists. As a result, there is a growing need to develop a method for treating adhesive capsulitis using an apparatus or robotic assistance.

### DETAILED DESCRIPTION OF THE INVENTION

### Technical Problem

Prior studies on the treatment and rehabilitation of adhesive capsulitis have primarily focused on muscle activation in paralyzed patients who have lost motor function. However, the present invention is developed with the goal of improving joint flexibility in patients with adhesive capsulitis.

The shoulder stretching apparatus proposed in the embodiments of the present invention aims to replicate the actions of a physical therapist performing manual therapy, enabling the apparatus to support the shoulder and facilitate arm movement. The objective and technical challenge are to contribute significantly to the stability of the patient's shoulder while increasing the flexibility of the shoulder joint within the range that maintains the scapulohumeral rhythm.

### Technical Solution

The embodiments proposed in the present invention pertain to the design of an apparatus for the treatment of adhesive capsulitis patients, which assists in improving flexibility within the normal range of scapulohumeral rhythm (as defined by the unaffected shoulder or textbook-relative movements of the scapula and upper arm). According to an embodiment of the present invention, a shoulder stretching apparatus is proposed that can passively or actively assist the patient's shoulder stretching, which is largely composed of a scapula control unit for externally identifying and controlling the position of the scapula and an arm control unit for performing arm flexibility exercise. A shoulder stretching apparatus according to one embodiment of the present invention includes a scapula control unit (60) that controls the upward range of shoulder motion by applying a physical external force to the user's shoulder or scapula, including a contact unit formed to directly contact the user's shoulder or back; an arm control unit (50) that controls the movement of the arm so that the shoulder can move within the limit range of motion of the shoulder; and an integrated control unit that transmits a command to control movement to the scapula control unit and the arm control unit according to the transmitted shoulder range of motion information

The scapula control unit applies external force to press the upper shoulder to prevent it from exceeding the limit range of motion when the user raises their arm, and the contact portion is located on the upper shoulder and may be formed as a rod extending forward from the user's back or a curved surface covering the trapezius muscle.

The scapula control unit may apply an external force to support and push up the user's shoulder blade from the rear when the user raises his or her arm, and the contact unit may be formed in a shape that catches the shoulder blade when the user uses his or her arm to apply force forward or upward, and may include a supporter in one of the shapes including an L-shape, a triangle, a crescent shape, or a curved surface that wraps around the shoulder blade from the rear.

Additionally, the scapula control unit may apply an external force to push from the rear when the user's shoulder blade cannot be pulled toward the back, and the contact unit may have a shape of a curved or flat contact surface that is located at the rear of the shoulder blade and pushes the shoulder blade forward.

Additionally, the scapula control unit may apply force to push the scapula inward when it moves outwardly from the body's side, and the contact portion may be positioned on the lateral side of the scapula, covering it or forming a rod shape extending forward from the user's back.

The contact portion may be connected to the terminal of the scapula control unit, which is designed to have at least three degrees of freedom.

The shoulder stretching apparatus may assist or control the user's movement by considering the normal range of scapulohumeral rhythm.

The shoulder stretching apparatus according to one embodiment of the present invention comprises a vertically extending support shaft (10); a height adjustment unit (20) configured to fit into the support shaft and capable of height adjustment; a link arm (30) with one end connected to the height adjustment unit and extending to connect with the scapula control unit or the linkage unit; a scapula control unit (60) connected to the support shaft or the link arm to support the shoulder's axis and limit the upward movement range of the shoulder; a shoulder range-of-motion sensing unit (40) connected to the link arm to measure the shoulder's limit range of motion; an arm control unit (50) connected to the shoulder range-of-motion sensing unit to support the arm and control its movement within the set range of motion; and a control unit that delivers commands to adjust the movements of the scapula control unit and arm control unit based on the range-of-motion data received from the shoulder range-of-motion sensing unit.

According to one embodiment of the invention, the shoulder range-of-motion sensing unit may be capable of measuring torque in all three axes of the shoulder.

According to one embodiment of the invention, the shoulder range-of-motion sensing unit may perform sensing with the axis of the glenohumeral joint aligned with the axis of the sensor.

According to one embodiment of the invention, the scapula control unit may include an acromion (66) extending forward toward the front of the user, designed to restrict the upward movement of the shoulder.

According to one embodiment of the invention, the height adjustment unit may allow rotational movement in a horizontal direction, referred to as the first plane direction (first degree of freedom), the link arm may allow rotational movement in a vertical direction perpendicular to the first plane direction (second degree of freedom) at its connection with the height adjustment unit, and the shoulder range-of-motion sensing unit may allow rotational movement in the vertical plane (third degree of freedom) at its connection with the link arm.

According to one embodiment of the invention, the arm control unit may include a first connector supporting the upper arm from the shoulder; a second connector connected to one end of the first connector and supporting the lower arm above the elbow; and a third connector extending from the other end of the second connector to support the elbow from below.

According to one embodiment of the invention, the first connector may be capable of rotational movement in a direction perpendicular to both the first plane direction and the second plane direction, referred to as the third plane direction (fourth degree of freedom), at its connection with the shoulder range-of-motion sensing unit, and the portion of the third connector that contacts the elbow may allow rotational movement in a direction perpendicular to the third plane, referred to as the fourth plane direction (fifth degree of freedom).

According to one embodiment of the invention, the arm control unit comprises an upper arm support and a lower arm support, and the part where the upper arm support and the lower arm support overlap slides according to the length of the wearer's upper arm, and may include a slide part that can adjust the length.

According to one embodiment of the invention, the link arm may comprise a first link arm formed adjacent to the height adjustment unit and a second link arm connected to one end of the first link arm and extending from it, wherein the connection between the first link arm and the second link arm comprises a sliding structure that allows the overlapping length of the first and second link arms to be adjusted based on the user's body shape, thereby enabling the length of the link arm to be modified.

According to another embodiment of the invention, a system for adhesive capsulitis exercise therapy using the shoulder stretching apparatus may collect and accumulate treatment data obtained through the shoulder stretching apparatus described in the foregoing embodiments and propose patient-specific exercise therapy algorithms using an algorithm constructed based on the collected data.

According to yet another embodiment of the invention, a shoulder exercise therapy method using the shoulder stretching apparatus may be employed to treat shoulder patients or to allow general users to perform shoulder stretching. This method involves physically pressing the patient's shoulder using the shoulder stretching apparatus during the exercise process to maintain the scapulohumeral rhythm, while also utilizing the shoulder stretching apparatus to confirm the appropriate range of motion for the patient's shoulder and enabling shoulder movement within the determined range.

According to yet another embodiment of the invention, a shoulder exercise therapy method using the shoulder stretching apparatus may be used to treat patients with shoulder conditions or to allow general users to perform shoulder stretching, and this method involves utilizing the apparatus to physically press the patient's shoulder during the exercise process to maintain the scapulohumeral rhythm, as well as to confirm the appropriate range of motion for the shoulder and enable movement within this range.

### Advantages of the Invention

For patients with adhesive capsulitis, treatment should focus more on restoring the reduced range of motion caused by stiffened tissues rather than on the absence of muscle strength. However, existing upper limb rehabilitation robots are primarily designed to enhance muscle strength for paralyzed patients, rather than to improve flexibility, which limits their effectiveness in treating adhesive capsulitis patients.

The effect of using a shoulder stretching apparatus according to one embodiment of the present invention is that it can maintain the scapulohumeral rhythm so that the range of motion can be increased within normal movement.

Patients with adhesive capsulitis often unconsciously elevate their scapula to compensate for the restricted range of motion caused by a stiffened shoulder during the process of abducting and lifting their arm, and by maintaining the scapulohumeral rhythm as described above, the apparatus enables the patient to perform stretching while suppressing such compensatory movements and keeping them within a normal range.

The shoulder stretching apparatus according to one embodiment of the present invention helps adhesive capsulitis patients improve flexibility while simultaneously learning to maintain a normal scapulohumeral rhythm.

These embodiments of the present invention can also be applied to patients with hemiplegic shoulder pain exhibiting similar symptoms. Furthermore, they are expected to provide beneficial effects even when used for shoulder stretching in individuals without related symptoms.

### BRIEF DESCRIPTION OF THE DRAWINGS

FIG. 1 is a drawing showing the form in which the scapula moves according to each movement when a person moves his or her shoulder.

FIG. 2 is a schematic diagram showing the structure of a shoulder stretching apparatus according to one embodiment of the present invention when viewed from the back.

FIG. 3 is a schematic diagram showing the structure of a general form in which a patient wears the shoulder stretching apparatus of FIG. 2 and moves his or her shoulder when viewed from the back, showing the form in which the patient abnormally raises the shoulder joint.

FIG. 4 is a schematic diagram showing the structure of a patient's shoulder when the scapula control unit suppresses the elevation of the shoulder when the patient wears the shoulder stretching apparatus of FIG. 2 and moves his or her shoulder, showing the form in which the patient's shoulder moves within the normal range of motion when viewed from the back.

FIG. 5 is a schematic diagram showing the structure of a shoulder stretching apparatus according to another embodiment of the present invention when viewed from the back.

FIG. 6 is a schematic diagram showing the form in which a patient wears the shoulder stretching apparatus of FIG. 5 when viewed from the rear.

FIG. 7 is a schematic diagram showing the degree of freedom of the portion where the rotational movement of the shoulder stretching apparatus occurs when the patient moves the shoulder while wearing the shoulder stretching apparatus of FIG. 5.

FIG. 8 is a diagram showing the plane where the rotational movements occur in order to explain each rotational movement in the drawing shown in FIG. 6.

FIG. 9 is a diagram showing an example of a design diagram in which a scapula control unit is implemented in a form that can wrap or hold the inside of the neck (trapezius muscle area) from the upper part of the shoulder in a shoulder stretching apparatus according to another embodiment of the present invention.

FIG. 10 is a diagram showing an example (L-shaped) in which a scapula control unit is implemented in a form that supports the back toward the upper part by contacting the back from the lower part of the shoulder blade (a structure that drives by pushing and sweeping up the shoulder blade) in a shoulder stretching apparatus according to another embodiment of the present invention.

FIG. 11 is a diagram showing an example in which a scapula control unit is implemented in a form that pushes from the rear of the shoulder blade in a shoulder stretching apparatus according to another embodiment of the present invention.

FIG. 12 is a drawing showing an example of a shoulder stretching apparatus according to another embodiment of the present invention in which a scapula control unit is implemented in a form that covers the shoulder on the outer side of the shoulder.

FIG. 13 is a drawing explaining the process of developing a shoulder stretching apparatus of the present invention to treat a patient with adhesive capsulitis.

### FORM FOR IMPLEMENTING THE INVENTION

The embodiments of the present disclosure are exemplified for the purpose of explaining the technical idea of the present disclosure. The scope of rights according to the present disclosure is not limited to the embodiments presented below or the specific description of these embodiments.

All technical terms and scientific terms used in the present disclosure have meanings generally understood by those of ordinary skill in the art to which the present disclosure belongs, unless otherwise defined. All terms used in the present disclosure have been selected for the purpose of more clearly explaining the present disclosure and are not selected to limit the scope of rights according to the present disclosure.

Expressions such as “comprising,” “having,” and the like used in the present disclosure should be understood as open-ended terms that imply the possibility of including other embodiments, unless otherwise stated in the phrase or sentence in which the expression is included.

Singular expressions described in the present disclosure may include plural meanings unless otherwise stated, and this also applies to singular expressions described in the claims.

Hereinafter, embodiments of the present disclosure will be described with reference to the attached drawings. In addition, in the description of the embodiments below, redundant description of identical or corresponding components may be omitted. However, even if the description of a component is omitted, it is not intended that such component is not included in any embodiment.

The human shoulder is structured as a ball and socket, but in order to secure the range of motion, it has a shallow socket structure with low safety. There are various structural and mechanical stabilizing elements to compensate for this shoulder instability. In particular, the scapulohumeral rhythm can be understood as a role that moves the scapula according to the degree of abduction of the upper arm to prevent the upper arm from moving out of the shallow socket position.

Patients with adhesive capsulitis gradually become accustomed to movements in which the scapulohumeral rhythm is disrupted due to the shoulder not being abducted. In this way, patients with adhesive capsulitis are likely to train in a range that deviates from the normal rhythm during rehabilitation exercise, but such exercise can rather cause other diseases.

According to the embodiment of the shoulder stretching apparatus proposed in the present invention, by holding and controlling the patient's shoulder during the exercise so that this scapulohumeral rhythm is continuously maintained, more effective treatment can be expected compared to previous studies on rehabilitation robots for adhesive capsulitis patients that simply performed stretching.

The embodiments proposed in the present invention relate to a apparatus design for the purpose of treating a patient with adhesive capsulitis, and may relate to a apparatus and robot that helps increase flexibility within a normal range (a range based on the movement of the patient's shoulder without a lesion, or a textbook relative movement of the scapula and upper arm) of the scapulohumeral rhythm that contributes to the stability of a person's shoulder. According to an embodiment of the present invention, a shoulder stretching apparatus that can passively or actively assist a patient's shoulder stretching is proposed, which is largely composed of a scapula control unit for externally identifying and controlling the position of the scapula and an arm control unit for performing arm flexibility exercise.

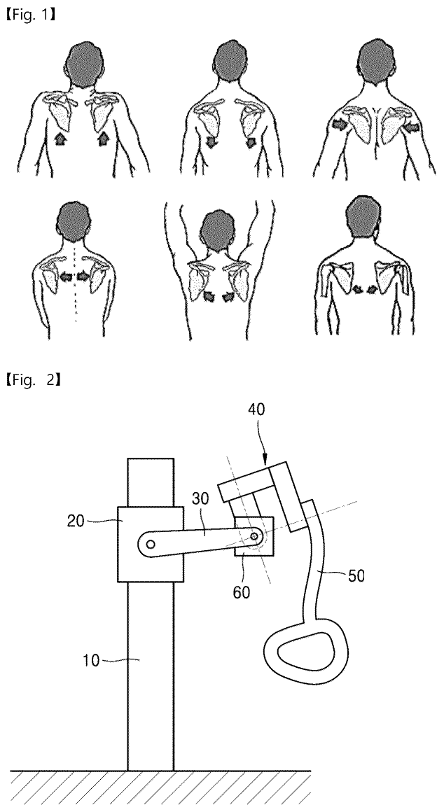

FIG. 1 is a drawing showing the form in which the scapula moves according to each movement when a person moves the shoulder. The shoulder stretching apparatus proposed in the present invention may be a apparatus that supports the shoulder and scapula or applies an external force to assist the movement so that the shoulder moves within a normal range when shoulder movement occurs.

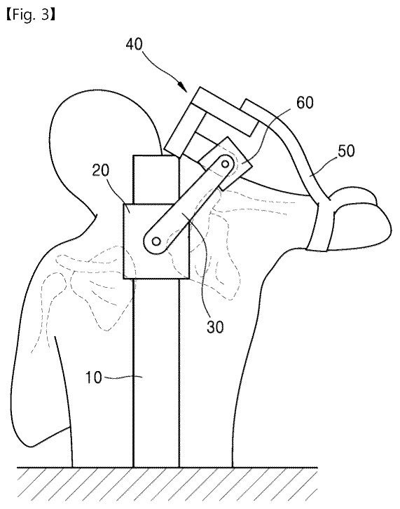

FIG. 2 is a schematic diagram showing the structure of a shoulder stretching apparatus according to an embodiment of the present invention as viewed from the back. Below, each part of the shoulder stretching apparatus illustrated in FIG. 2 is described in detail with reference to FIG. 2.

A shoulder stretching apparatus according to one embodiment of the present invention comprises a scapula control unit (60) configured to control the upward range of motion of a shoulder by applying a physical external force to a user's shoulder or shoulder blade, including a contact unit formed to directly contact the user's shoulder or back; an arm control unit (50) configured to control the movement of an arm so that the shoulder can move within the shoulder's limit range of motion; and an integrated control unit configured to transmit a command to control movement to the scapula control unit and the arm control unit according to the transmitted shoulder range of motion information.

The above scapula control unit applies an external force to press the shoulder so that the shoulder does not go out of the upper range of motion when the user raises the arm, and the contact unit may be located at the upper part of the shoulder and may be formed with a structure including a rod structure extending from the back to the front of the user or a curved surface covering and wrapping the trapezius muscle from the upper part.

The above scapula control unit applies an external force to support and push up the user's shoulder from the rear when the user raises the arm, and the contact unit is formed in a shape that catches the shoulder blade when the user uses the arm to apply force forward or upward, and may include a support body in one of the shapes including an L-shape, a triangle, a crescent shape, or a curved shape that wraps around the shoulder from the rear.

The above contact portion may be in a form connected to the end of a shoulder control portion formed to have at least three degrees of freedom.

According to one embodiment of the present invention, a shoulder stretching apparatus comprises: a support shaft (10) formed to extend in a vertical direction; a height adjustment unit (20) fitted to the support shaft and capable of adjusting the height; a link arm (30) having one end connected to the height adjustment unit; a scapula control unit (60) that holds the axis of the shoulder and simultaneously suppresses the upward range of motion of the shoulder; a shoulder range of motion sensing unit (40) having one end connected to the link arm and measuring the limit range of motion of the shoulder; an arm control unit (50) that supports the arm and simultaneously controls the movement of the arm so that the shoulder can move within a set range of motion; and an integrated control unit that transmits a command to control the movement to the scapula control unit and the arm control unit according to the range of motion information of the shoulder received from the range of motion sensing unit.

The above support shaft is positioned in the middle of the patient's back during rehabilitation treatment, and the height adjustment unit and the link arm are both positioned on the patient's back.

The scapula control unit may have a structure in which one side is connected to the height adjustment unit like a link arm, or the scapula control unit may have a structure in which the other side is connected to the opposite side of the one side connected to the height adjustment unit of the link arm. The scapula control unit may suppress abnormal elevation of the shoulder joint during shoulder movement of the patient.

The shoulder range of motion sensing unit may have a function of connecting the link arm located on the back side of the patient and the arm control unit extended below the shoulder. As an example, the shoulder range of motion sensing unit may be formed as a double-bent connection structure as shown in FIG. 1 or FIG. 4.

The arm control unit may be formed of a flexible material so that it can be fitted to the elbow and perform a movement reflecting multiple degrees of freedom of the arm (FIG. 1), and in another embodiment, it may be formed as a flat panel formed by extending a rigid material (FIG. 4).

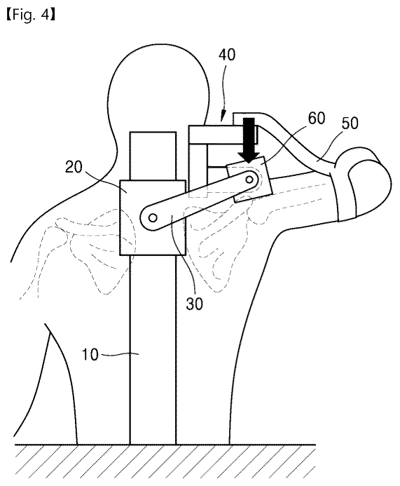

As shown in FIGS. 3 and 4 described below, the scapula control unit is designed to perform the role of holding and controlling the shoulder in order to control the movement of the shoulder from the outside.

FIG. 3 is a schematic diagram showing the structure as viewed from the back when a patient wears the shoulder stretching apparatus of FIG. 2 and moves the shoulder, and it shows that a patient with adhesive capsulitis abnormally raises the shoulder joint.

FIG. 4 is a schematic diagram showing the structure as viewed from the back when a patient wears the shoulder stretching apparatus of FIG. 2 and moves the shoulder, and when the scapula control unit suppresses the elevation of the shoulder, the patient's shoulder moves within the normal range of motion.

FIG. 4 shows that when a patient attempts an abnormal shoulder elevation movement, the scapula control unit is fixed at a set position to control the patient's shoulder elevation movement, and through this, a patient with adhesive capsulitis moves the shoulder in a normal orbit. The above scapula control unit can be applied in various ways as long as it has a form that can control shoulder elevation, and as an example, the scapula control unit can be formed with a structure that includes an acromion that is formed to extend long toward the front of the patient.

The above scapula control unit can perform the role of holding the shoulder of a patient with adhesive capsulitis to create forward and backward and/or upward and downward movements, or restraining the movement of the scapula so as to suppress excessive movement of the patient's scapula.

In patients with adhesive capsulitis, the most prominent incorrect movement of the scapula is upward and downward movement. At this time, if the movement of the scapula is simplified to at least allow movement in two directions, upward and downward, and appropriately controlled, a great effect in the treatment of adhesive capsulitis can be expected.

According to one embodiment of the present invention, the shoulder range of motion sensing unit may be capable of measuring all three-axis torques of the shoulder.

The three-axis directions of the shoulder refer to the movement directions of the shoulder in the three-axis directions of front and back, left and right, and up and down.

The shoulder range of motion sensing unit may use a means capable of measuring torque, such as a torque sensor or a SEA (Series Elastic Actuator), to measure the limit range of motion of the shoulder. At this time, the limit range of motion of the shoulder can be predicted by measuring the change in force moving in the opposite direction of the direction in which the shoulder stretching apparatus rotates.

This method of predicting the limit range of motion of the shoulder may utilize the behavior of a person unconsciously exerting force when the shoulder reaches the limit range of motion, and the repulsive force generated by the tension of elements such as ligaments or tendons that cause the limit range of motion.

According to one embodiment of the present invention, the shoulder range of motion sensing unit may perform sensing in a state where the axis of the upper arm joint and the axis of the sensor are aligned.

The shoulder range of motion sensing unit may simultaneously align the axis of the shoulder and the shoulder stretching apparatus and determine the limit range of motion of the shoulder.

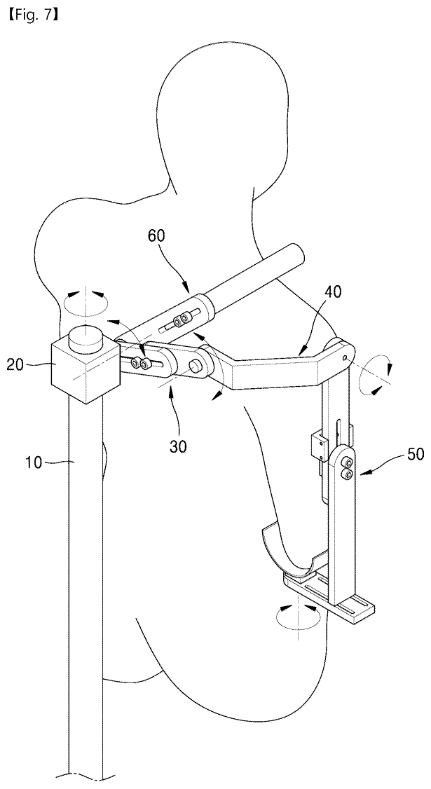

FIG. 2 illustrates the axis of the patient's shoulder and the shoulder stretching apparatus. The axis of the shoulder is defined as the central axis around which the upper arm joint rotates, and the axis of the apparatus refers to the last three degrees of freedom (the last three rotation axes of the arm control unit in FIG. 7) for rotating the arm along the axis.

At this time, two methods, a direct method and an indirect method, can be used for aligning the axis of the shoulder and the shoulder stretching apparatus. The axis alignment using the direct method is a method in which the apparatus is fixed by aligning the axis of the shoulder to the patient's upper arm, and the axis of the shoulder stretching apparatus also naturally moves along the axis of the shoulder as the arm moves. Indirect method of axis alignment can be used to predict the axis of the patient's shoulder by checking the movement of the patient's scapula control unit, and if the predicted shoulder axis position deviates significantly from the actual arm control unit axis position, it can be used to notify the user and recommend correction.

This can protect the patient from an environment where incorrect alignment can reduce exercise effectiveness or cause injury.

The arm control unit may be configured to perform the role of moving and exercising the arm of a patient with adhesive capsulitis. The arm control unit may be implemented to have at least five or more degrees of freedom, including two degrees of freedom that enable the arm to move up and down, forward and backward, and three degrees of freedom that enable the arm to rotate three-axis along the shoulder movement created by the scapula at least at the center of the body, and three degrees of freedom that enable the arm to rotate.

The scapula control unit and the arm control unit may be configured as a pair, and the scapula control unit and the arm control unit may be structured to be systematically connected to each other through a range of motion detection unit and a control unit.

When the scapula control unit and the arm control unit are provided as a pair, the shoulder stretching apparatus may be configured as a single-arm type, where one pair is alternately used for both arms depending on the situation, or as a dual-arm type with two symmetrical pairs that allow simultaneous use for both arms.

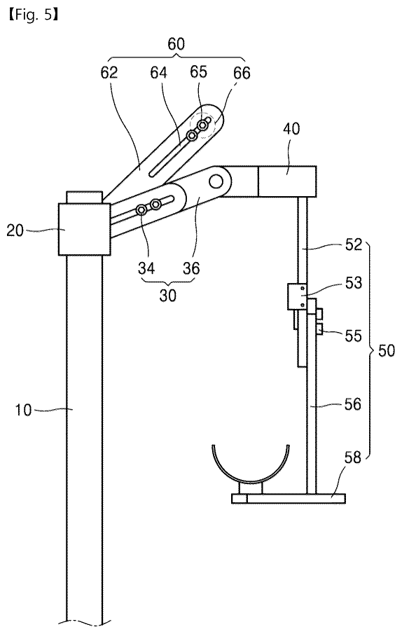

Hereinafter, another aspect of a shoulder stretching apparatus proposed in another embodiment of the present invention will be described using FIGS. 5 to 7.

FIG. 5 is a schematic diagram showing the structure of a shoulder stretching apparatus according to another embodiment of the present invention when viewed from the back.

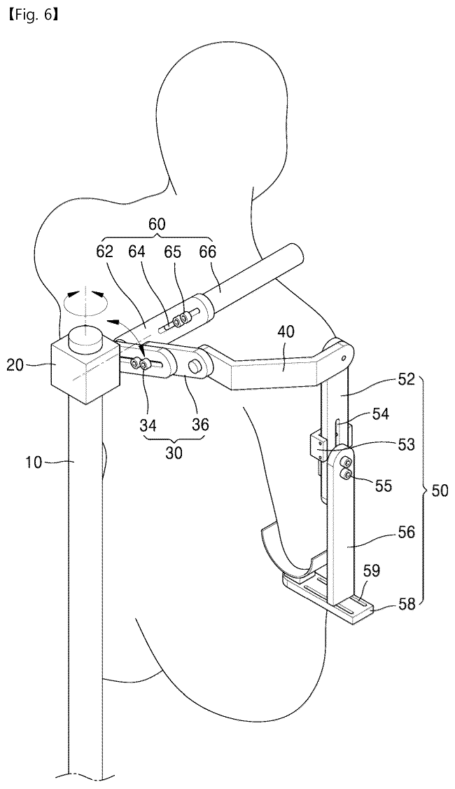

FIG. 6 is a schematic diagram showing the form of a patient wearing the shoulder stretching apparatus of FIG. 5 when viewed from the rear side.

FIG. 7 is a schematic diagram showing a part of a shoulder stretching apparatus where rotational movement occurs when a patient moves his shoulder when wearing the shoulder stretching apparatus of FIG. 5.

The shoulder stretching apparatus according to another embodiment shown in FIGS. 5 to 7 has different features from the shoulder stretching apparatus according to one embodiment shown in FIGS. 2 to 4 in terms of the acromion portion, the components of the shoulder control portion, and the structure of the arm control portion.

First, the shoulder stretching apparatus according to another embodiment shown in FIGS. 5 to 7 includes a form in which the acromion extends long from one side of the shoulder control portion toward the front of the patient. In addition, the scapula control unit is not directly connected to the shoulder range of motion sensing unit, and the arm control unit is made of a rigid material and has a panel structure that extends long from the upper arm toward the elbow.

According to one embodiment of the present invention, the scapula control unit may be provided with an acromion (66) that extends toward the front of the wearer and suppresses upward movement of the shoulder.

As an example, the acromion (66) may be fixed to the slide part (64) of the shoulder control link part (62) forming part of the scapula control unit (60) through a pin structure (65). At this time, the position of the acromion may be moved and fixed on the shoulder control link part through the slide part (64) depending on the height of the patient's shoulder or body shape.

In one embodiment, the above-described scapula control unit may be designed to implement at least two degrees of freedom movement, i.e., upward and downward, forward and backward. One end of the scapula control unit may be implemented to have a mechanism that can suppress upward movement of the patient's shoulder by grabbing the acromion or the clavicle area located a little further inward and pressing down and pushing and pulling forward and backward.

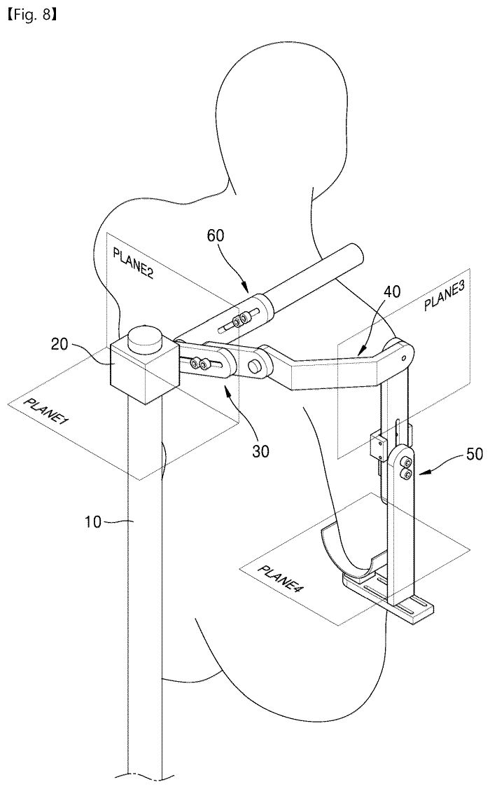

As shown in FIGS. 6 and 7, each component, including the height adjustment unit, link arm, and shoulder range of motion sensing unit, can be designed to rotate in its own direction to increase the effect of rehabilitation exercise. FIG. 8 is a drawing illustrating a plane on which each rotational movement occurs in order to explain each rotational movement in the drawing shown in FIG. 7.

According to one embodiment of the present invention, the height adjustment unit may allow rotational movement in a horizontal direction, referred to as the first plane direction, the link arm may allow rotational movement in a vertical direction perpendicular to the first plane direction at its connection with the height adjustment unit, and the shoulder range-of-motion sensing unit may allow rotational movement in the second plane direction at its connection with the link arm.

According to one embodiment of the present invention, the arm control unit may include a first connecting portion (52) that supports the upper arm from the shoulder; a second connecting portion (56) that is connected to one end of the first connecting portion and supports the lower arm above the elbow; and a third connecting portion (58) that is extended and formed to support the elbow from below and is connected to the other end of the second connecting portion that is not connected to the first connecting portion.

As an example, the first connecting portion and the second connecting portion may be configured with a slide portion (54) that can control the length of the overlapping connecting portion according to the length of the patient's arm and a pin portion (55) that can fix the sliding position, and may be configured to include a first connecting portion support member (53) that supports the first connecting portion outward from the patient's arm side.

According to one embodiment of the present invention, the first connecting portion may be capable of rotational movement (fourth degree of freedom) in a third plane direction perpendicular to the first plane direction and the second plane direction at the connection portion with the shoulder range of motion sensing portion, and the elbow contact portion of the third connecting portion may be capable of rotational movement (fifth degree of freedom) in a fourth plane direction perpendicular to the third plane.

The fourth plane direction may be parallel to the first plane direction and perpendicular to the third plane direction when the stretching apparatus is in its initial neutral state before performing exercise. However, in the process of the patient exercising using the stretching apparatus, the fourth plane direction may be performed in a plane direction that is perpendicular only to the third plane direction and is not parallel to the first plane direction.

According to one embodiment of the present invention, the arm control unit may include an upper arm support unit and a lower arm support unit, and may include a slide unit (54) in which a portion where the upper arm support unit and the lower arm support unit overlap each other slides and the length can be adjusted according to the length of the wearer's upper arm.

According to one embodiment of the present invention, the link arm includes a first link arm (34) formed adjacent to a height adjustment portion and a second link arm (36) formed to extend and be connected to one end of the first link arm, and the connection between the first link arm and the second link arm may be such that the overlapping length of the first link arm and the second link arm is adjusted and slid according to the body shape of the wearer through a slide structure, thereby allowing the length of the link arm to be changed.

An embodiment of using a shoulder stretching apparatus according to an embodiment of the present invention is as follows.

Before using the shoulder stretching apparatus, the patient's condition is assessed. For example, it may be important to determine whether the affected arm is on one side or both sides.

If the patient has a lesion on only one arm, the scapula control unit is attached to the patient's shoulder (near the acromion or clavicle) on the non-lesioned arm to record normal arm movements, and the arm control unit is attached to the upper arm or near the elbow with the arm not spread as the basic posture, and the shoulder stretching apparatus is attached. The method for attaching the shoulder stretching apparatus to the lesioned arm that will be exercised later is the same.

Depending on the stretching method planned to be performed, the arm control unit moves in various directions (forward or backward, raising or lowering, arm outstretching, internal or external rotation of the arm) depending on the patient's arm control in a relaxed state (passive stretching) and/or the patient's own movement (active stretching), and the shoulder range of motion sensing unit detects the limit range of motion of the shoulder through the movement of the scapula control unit and the arm control unit and the change in the measured torque occurring in the reverse direction of the movement.

Based on the identified information regarding the shoulder's limit range of motion, the shoulder stretching apparatus is applied to the affected arm, and exercises are performed using this information. If the apparatus detects that the shoulder has reached its limit range of motion without achieving a full movement, further stretching beyond this range is not forced, thereby ensuring the effectiveness of the stretching while preventing injuries caused by excessive stretching. If both arms are affected and no data on normal movement is available for reference, the exercise can be performed following the scapulohumeral rhythm known from standard anatomical guidelines.

Data obtained during these exercises can also be used to determine the treatment progress of patients with adhesive capsulitis.

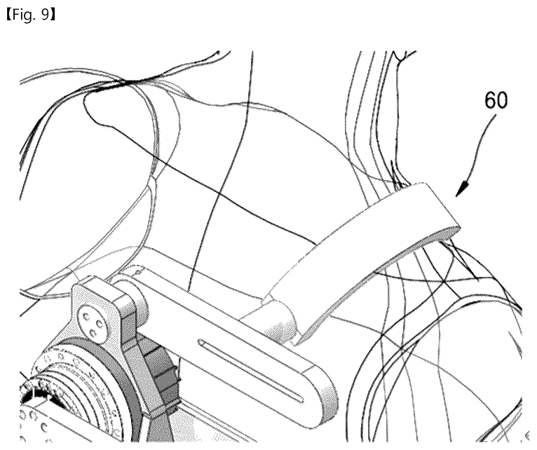

FIG. 9 is a drawing illustrating an example of a design diagram in which a scapula control unit is implemented in a form that can wrap or hold the inside of the neck (trapezius muscle area) from the upper part of the shoulder in a shoulder stretching apparatus according to another embodiment of the present invention.

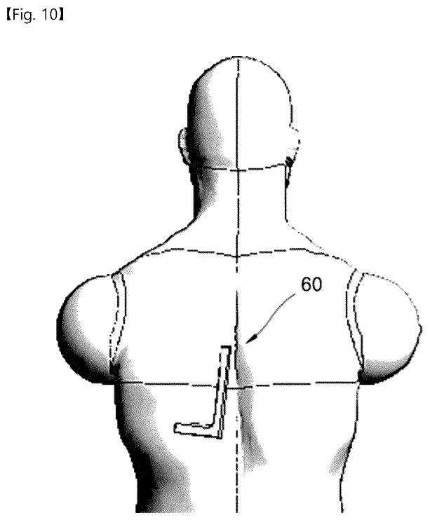

FIG. 10 is a drawing illustrating an example (L-shaped) of a shoulder stretching apparatus according to another embodiment of the present invention, in which a scapula control unit is implemented in a form that supports the back toward the upper part of the shoulder blade while contacting the back from the lower part of the shoulder blade (a structure that operates by pushing and sweeping up the shoulder blade).

The shoulder stretching apparatus of the present invention can be configured in various forms, including a scapula control unit and a contact unit included therein, and as shown in FIGS. 9 and 10, a contact unit is formed at the end of the scapula control unit, and the contact unit may be configured in a form that wraps around or holds the trapezius muscle from above, or in another example, the contact unit may be configured in a form that supports the scapula from behind and pushes or lifts it.

The forms illustrated in FIGS. 9 and 10 are merely examples of implementations in which the technical features to be implemented in the present invention are implemented, and show a case in which the mechanism is set based on one shoulder. If the mechanism is set on the opposite shoulder, the shoulder control portion and the contact portion included therein may be formed in a symmetrical form.

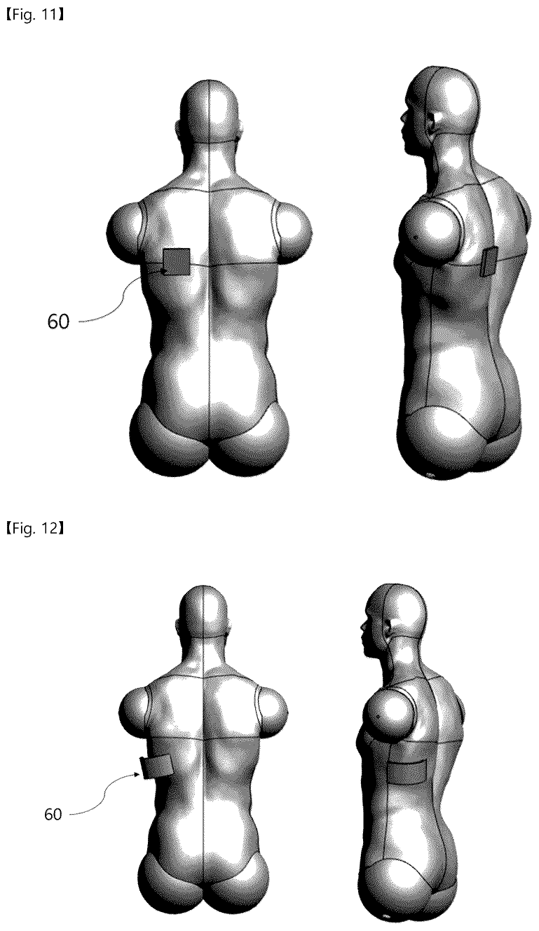

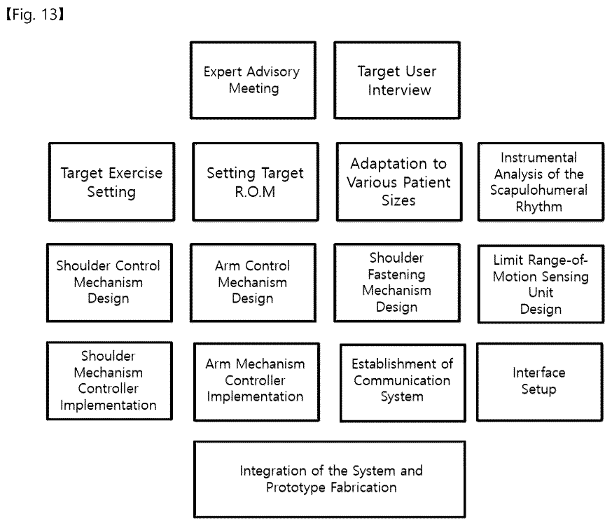

FIG. 11 is a drawing illustrating the process of developing a shoulder stretching apparatus of the present invention for treating a patient with adhesive capsulitis.

According to another embodiment of the present invention, a system for adhesive capsulitis exercise treatment using a shoulder stretching apparatus may collect and accumulate treatment data of patients obtained using the shoulder stretching apparatus of claim 1, and propose an exercise treatment algorithm customized for each patient through an algorithm constructed using the data.

According to another embodiment of the present invention, a shoulder exercise treatment method using a shoulder stretching apparatus can maintain the scapulohumeral rhythm of the shoulder by physically pressing the patient's shoulder using a shoulder stretching apparatus during the shoulder exercise process, and at the same time, use the shoulder stretching apparatus to check the appropriate range of motion of the patient's shoulder and enable the shoulder to be exercised within the appropriate range of motion.

The above description is merely an illustrative description of the technical idea of the present invention, and those skilled in the art will appreciate that various modifications and variations may be made without departing from the essential characteristics of the present invention. Accordingly, the embodiments disclosed in the present invention are not intended to limit the technical idea of the present invention but to explain it, and the scope of the technical idea of the present invention is not limited by these embodiments. The protection scope of the present invention should be interpreted by the following claims, and all technical ideas within a scope equivalent thereto should be interpreted as being included in the scope of the rights of the present invention.

### DESCRIPTION OF SYMBOLS

10: Support shaft
20: Height adjustment part
30: Link arm
34:36:
40: Shoulder range of motion sensing part
50: Arm control part
52: First connection part, 53: First connection support,
55: Pin part, 56: Second connection part,
58: Third connection part, 59: Elbow slide part
60: Scapula control part
62: Shoulder control link part, 64: Slide part
65: Pin structure, 66: Acromium

1. A shoulder stretching apparatus comprising: a scapula control unit that controls the position of a shoulder by applying a physical external force to a user's shoulder or shoulder blade, including a contact unit formed to directly contact the user's shoulder or back;
an arm control unit that controls the movement of an arm so that the shoulder can move within the shoulder's range of motion; and
an integrated control unit that transmits a command to control movement to the scapula control unit and the arm control unit according to the transmitted shoulder range of motion information.

2. The shoulder stretching apparatus according to claim 1,
wherein the scapula control unit applies an external force to press the shoulder from above when the user raises their arm, thereby suppressing excessive upward movement of the shoulder or assisting in preventing it from lowering,
wherein the contact portion is positioned on the upper part of the shoulder and is formed in a structure that includes either a rod-shaped structure extending forward from the user's back or a curved surface that covers and wraps around the trapezius muscle from above.

3. The shoulder stretching apparatus according to claim 1,
wherein the scapula control unit applies an external force to support and push up the user's scapula from the rear when the user raises their arm,
wherein the contact portion is positioned at the rear of the scapula and is formed in a shape that restricts the scapula when the user applies force forward or upward with their arm, and includes one of a supporting structure such as an L-shape, a triangular shape, a crescent shape, or a curved surface that wraps around the scapula from the rear.

4. The shoulder stretching apparatus according to claim 1,
wherein the scapula control unit applies an external force from the rear to push the user's scapula forward when the scapula cannot retract toward the back,
wherein the contact portion is positioned at the rear of the scapula and has a shape selected from a curved surface or a flat contact surface that pushes the scapula forward.

5. The shoulder stretching apparatus according to claim 1,
wherein the scapula control unit applies an external force to push the user's scapula inward when it moves outward from the side of the body,
wherein the contact portion is positioned on the outer side of the scapula and is formed in a shape that either covers the scapula or extends forward from the user's back in the form of a rod.

6. The shoulder stretching apparatus according to claim 1,
wherein the contact portion is formed to be connected to the distal end of the scapula control unit, which is configured to have at least three degrees of freedom.

7. A shoulder stretching apparatus comprising:
a support shaft extending in a vertical direction;
a height adjustment unit configured to be fitted to the support shaft and adjustable in height;
a link arm having one end connected to the height adjustment unit and extending to connect with a scapula control unit or a connecting portion;
a scapula control unit having one end connected to the support shaft or the link arm, configured to hold the shoulder's axis and simultaneously control the movement of the scapula;
a shoulder range-of-motion sensing unit having one end connected to the link arm, configured to measure the limit range of motion of the shoulder;
an arm control unit connected to the other end of the shoulder range-of-motion sensing unit, configured to support the arm and control its movement within the predetermined range of motion; and
an integrated control unit configured to transmit commands to control the movements of the scapula control unit and the arm control unit based on shoulder range-of-motion data received from the shoulder range-of-motion sensing unit.

8. The shoulder stretching apparatus according to claim 7,
wherein the shoulder range-of-motion sensing unit is configured to measure torque in all three axes of the shoulder.

9. The shoulder stretching apparatus according to claim 7,
wherein the shoulder range-of-motion sensing unit is configured to perform sensing with the axis of the glenohumeral joint aligned with the axis of the sensor.

10. The shoulder stretching apparatus according to claim 7,
wherein the scapula control unit comprises an acromion (66) extending toward the front of the wearer, configured to suppress upward movement of the shoulder.

11. The shoulder stretching apparatus according to claim 7,
wherein the height adjustment unit is capable of rotational movement in a horizontal direction, referred to as the first plane direction (first degree of freedom),
wherein the link arm is capable of rotational movement in a second plane direction perpendicular to the first plane direction (second degree of freedom) at its connection with the height adjustment unit, and
wherein the shoulder range-of-motion sensing unit is capable of rotational movement in the second plane direction (third degree of freedom) at its connection with the link arm.

12. The shoulder stretching apparatus according to claim 7,
wherein the arm control unit comprises:
a first connecting portion configured to support the upper arm from the shoulder;
a second connecting portion connected to one end of the first connecting portion and configured to support the lower arm above the elbow; and
a third connecting portion connected to the other end of the second connecting portion, which is not connected to the first connecting portion, and extending to support the elbow from below.

13. The shoulder stretching apparatus according to claim 12,
wherein the first connecting portion is capable of rotational movement (fourth degree of freedom) in a third plane direction, which is perpendicular to both the first plane direction and the second plane direction, at its connection with the shoulder range-of-motion sensing unit, and
wherein the portion of the third connecting portion that contacts the elbow is capable of rotational movement (fifth degree of freedom) in a horizontal direction, referred to as the first plane direction.

14. The shoulder stretching apparatus according to claim 7,
wherein the arm control unit comprises an upper arm support and a lower arm support,
wherein a sliding portion is configured to allow the overlapping section of the upper arm support and the lower arm support to slide and adjust in length according to the length of the wearer's upper arm.

15. The shoulder stretching apparatus according to claim 7,
wherein the link arm comprises a first link arm formed adjacent to the height adjustment unit and a second link arm connected to one end of the first link arm and extending therefrom, and
wherein the connection between the first link arm and the second link arm is configured with a sliding structure that allows the overlapping length of the first link arm and the second link arm to be adjusted according to the wearer's body shape, enabling the length of the link arm to be modified.

16. A shoulder exercise therapy system,
wherein treatment data obtained from patients using the shoulder stretching apparatus according to claim 1 is collected and accumulated,
and a patient-specific exercise therapy algorithm is proposed using an algorithm constructed based on the collected data.

17. A method for shoulder exercise and therapy using a shoulder stretching apparatus,
wherein the method involves treating shoulder patients or enabling general users to perform shoulder stretching,
by maintaining the scapulohumeral rhythm of the shoulder through physically pressing the user's shoulder using the shoulder stretching apparatus during the shoulder movement process,
and by determining the appropriate range of motion for the user's shoulder using the shoulder stretching apparatus and enabling shoulder movement within the determined range of motion.
